(19) United States
(12) Patent Application Publication
(10) Pub. No.: US 2021/0250468 A1
(43) Pub. Date: Aug. 12, 2021

(54) INTERPOLATION AND SMOOTHENING OF THE GAMUT BOUNDARY

(71) Applicant: HEWLETT-PACKARD DEVELOPMENT COMPANY, L.P., Spring, TX (US)

(72) Inventors: Juan Miguel HUERTAS DELGADO, Sant Cugat del Valles (ES); Jordi VILAR BENITO, Sant Cugat del Valles (ES)

(21) Appl. No.: 17/048,972

(22) PCT Filed: Aug. 21, 2018
(86) PCT No.: PCT/US2018/047175

§ 371 Date: Oct. 19, 2020

(51) Int. Cl. H04N 1/60

(52) U.S. Cl. CPC H04N 1/6061; H04N 1/6019

(57) ABSTRACT

Disclosed herein is a method, in particular for interpolating and smoothening the gamut boundary of an image processing device. Color data are received. An initial surface corresponding to the color data in a color space is created and divided into first patches. A first one of the first patches is divided into second patches based on a topology of a second one of the first patches. Further disclosed are a corresponding machine-readable medium and a corresponding system comprising a storage device and a computing device.

### TECHNICAL BACKGROUND

An image processing device, such as a printing device, a display device, or an image capture device, may detect or reproduce a limited range of the colors. This limited range of the colors may be represented by a device-dependent color gamut, or simply gamut. As such, the gamut may represent an entirety of reproducible colors of an image processing device. A gamut also can be thought of as a color palette.

Color management may concern conversions between gamuts of various image processing devices. A target gamut, i.e. the gamut of a target image processing device, may differ from a source gamut, i.e. the gamut of a source device or a source image. Beside the conversion of colors that are within both the target and source gamuts, colors that are within the source gamut but not within the target gamut may not be accurately reproducible by the target image processing device.

### BRIEF DESCRIPTION OF THE DRAWINGS

Various features of the present disclosure will be apparent from the detailed description which follows in conjunction with the accompanying drawings.

FIG. 1 is a flow chart of a method according to an example;

FIG. 2A-2C are schematic diagrams illustrating a process of providing an initial surface and first patches according to an example;

FIG. 3 is a schematic diagram illustrating a mesh of first patches according to an example;

FIG. 4 is a schematic diagram illustrating a process of determining a new vertex according to an example;

FIG. 5A-5B are schematic diagrams illustrating a process of dividing a first patch into second patches according to an example;

FIG. 6A-6B are schematic diagrams of a gamut before and after subdivisions of first patches into respective second patches according to an example; and

FIG. 7 is a schematic diagram illustrating a system according to an example.

### DETAILED DESCRIPTION

A color space may provide a means for representing colors, such as colors perceptible by human eye, or a gamut of a specific image processing device. Examples of color spaces include CIELUV, CIELAB, RGB, sRGB, YUV, YCbCr, CMY(K), HSV, HSL, etc. The color spaces may be represented by means of a Cartesian, cylindrical, or spherical coordinate system in two, three, or more dimensions. Colors may be defined by a respective set of color coordinates representing a value along each axis of the selected coordinate system.

For example, tristimulus values may be represented by the coordinates X, Y and Z in a Cartesian coordinate system, which may referred to as CIEXYZ color space. The CIEXYZ color space may allow for a majority of perceptible colors to be identified based on its coordinates. In a further example, colors may be represented by its lightness, represented by L*, its green-red color component, represented by a*, and blue-yellow color component, represented by b*. A corresponding color space may be provided by CIE L*a*b* color space, which also may be referred to as CIELAB, or simply Lab color space. The CIELAB color space may be represented as a Cartesian coordinate system with the components L*, a* and b* as its basis. The CIELAB color space may provide an approximation to the human color perception. The CIEXYZ and CIELAB may be considered as color spaces that are device-independent.

RGB-based and CMY(K) color spaces may be considered as device-dependent color spaces. For example, an image processing device may represent colors based on red, green and blue as primary colors. The color space of such an image processing device may be represented in RGB or sRGB color space, in which said primary colors are represented as an orthogonal basis of a Cartesian coordinate system. In other examples, an image processing device may reproduce colors using cyan, magenta, and yellow as process colors. Black or key process color may be additionally used. The color space of such an image processing device may be represented in CMY(K) color space in which said process colors are represented as an orthogonal basis of a Cartesian coordinate system.

Gamut mapping may concern conversion of colors from a source gamut into the target gamut. In particular, the gamut mapping may provide for an approximate conversion of out-of-gamut colors, i.e. colors that are outside of the target gamut, from the source gamut into the target gamut. An effective gamut mapping may provide visually appealing color reproduction between devices with disparate color gamuts as well as an accurate reproduction of a source image. An exact knowledge of the respective gamut may contribute to an accurate gamut mapping. Moreover, since the volume of a gamut may be used for analysis and optimization of image processing devices, exact information about the respective gamut may be meaningful.

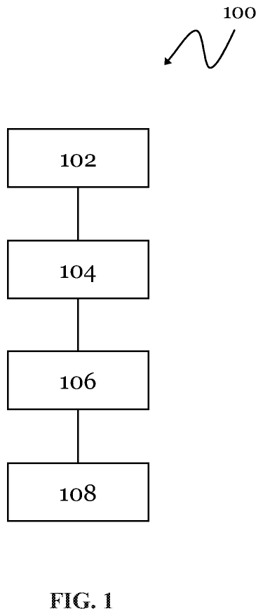

FIG. 1 is a flow chart of a method 100 according to an example. At 102, color data may be received. In some examples, the color data may relate to a set of colors that is reproducible by a device. For example, the color data may provide for representing a gamut of a device.

The color data may relate to a device including an image processing device capable of processing a color image, for example a printing device, a display device, or an image capture device. In some examples, the color data may provide information about a gamut of an image processing device. The color data may be provided by a storage medium that may be part of or external to the device. In some examples, the color data may be received via a network or any suitable communication means.

The color data may allow for representing a color set in a color space. Examples of a color space include CIEXYZ, CIELUV, CIELAB, CIEUVW, RGB, Adobe RGB, sRGB, scRGB, DCI-P3, ACES, YIQ, YUV, YDbDr, YPbPr, YCbCr, ICtCp, xvYCC, CMY(K), HSV, and HSL, including any modification or derivation thereof. Further examples may refer to commercial color spaces, such as Munsell color system, Natural Color System, Pantone Matching System, RAL, and standard color systems that are specific in some countries.

For example, the color data may allow for representing a gamut of an image processing device in the CMY(K) color space with respect to its process colors, or in the RGB or sRGB color space with respect to its additive colors.

In some examples, the color data may include vertices or nodes. Vertices or nodes may be understood as virtual constructs in a given color space indicative of colors or sets of colors. In the following, the term vertices is used for both vertices and nodes. A vertex may refer to a specific color or to a specific set of colors. In some examples, a vertex may refer to data indicating a specific color in both a device-dependent color space and a device-independent color space. In some examples, vertices may refer to data containing information for assigning device-dependent color values, determined with respect to a device-dependent color space, to respective device-independent color values, determined with respect to a device-independent color space.

The color data may be characteristic for a respective device, for example in terms of reproducible colors. For example, the color data may determine colors that are reproducible by a respective device. In some examples, the color data may provide a basis for assigning each color from a device-dependent color space, such as a RGB color space of a display device or CMY(K) color space of a printing device, to a corresponding color in a device-independent color space, such as the CIELAB or CIEXYZ. In a specific example, the color data may refer to a RGB-based device and provide vertices to be constructed in either of a device-dependent color space and a device-independent color space. Each vertex of the vertices may refer to a respective tuple of RGB-values within a device-dependent RGB color space or to a corresponding color value in the device-independent CIELAB color space. In another example, the color data may provide vertices allowing for assignment of device-dependent CMY(K) color values of a specific device to the respective color values in the CIELAB color space. Accordingly, the color data may provide for characterizing a respective device in terms of its color reproducibility. Furthermore, the gamut of a device may be derivable from the color data. In an example, the vertices provided by the color data of any color space may be referred to as initial vertices.

The initial vertices of a device may be obtained from a measurement or, alternatively or additionally, from a simulation. For example, the vertices may be obtained from sampling, the term sampling referring to performing a measurement or a simulation on a gamut of a device. In some examples, sampling may be performed with respect to primary or secondary colors of a respective device.

A vertex may be represented by a set of coordinates, e.g. by an n-tuple, wherein n corresponds to the dimension of the respective color space. In a vector space, a vertex may correspond to a specific vector. In some examples, a gamut of an image processing device may be derivable from the vertices provided by the color data. The vertices provided by the color data as disclosed herein may be referred to as initial vertices to distinguish from new or additional vertices obtained from a subdivision, as described below.

For example, the sampling may result in obtaining vertices in relation to the primary or secondary colors of the respective device. For example, the vertices may be obtained equidistantly with respect to either one of the primary colors in a respective color space in which the primary colors form a basis. In a specific example, the gamut of a RGB-based device may be sampled in a RGB color space, in which each of the primary colors R, G and B extends from 0 to 255, at every sixth along each of the primary colors, resulting in each of R, G and B being {0, 51, 102, 153, 204, 255} and therefore in 6³=216 vertices. Additionally or alternatively, the vertices may be obtained according to a lookup table, in accordance with an established standard, for example the ICC profile as promulgated by the International Color Consortium, or in any other appropriate manner to obtain a sufficient amount of information about the respective gamut.

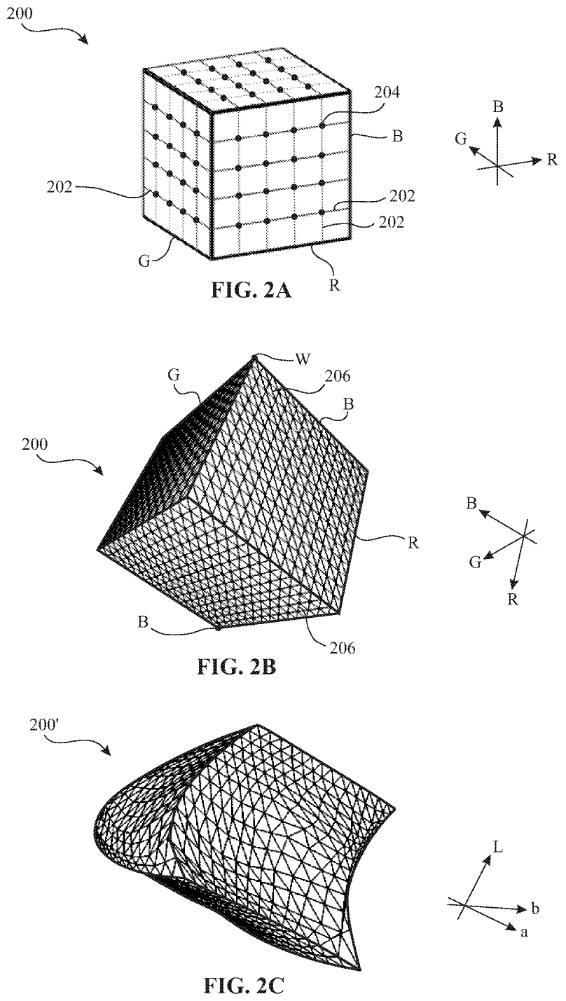

FIG. 2 shows schematic diagrams illustrating a process of providing an initial surface and first patches according to an example. FIG. 2A shows a gamut 200 which may have been obtained by sampling. In FIGS. 2A and 2B, the gamut 200 is being presented in a device-dependent RGB color space with the primary colors red R, green G and blue B as orthogonal basis in a Cartesian coordinate system. The sampling is indicated by sampling lines 202 parallel to either of the primary colors R, G and B. Each intersection point 204 of two sampling lines 202 represent a vertex. In FIGS. 2B and 2C, and indication by a respective reference numeral is omitted for the sake of visibility. With reference to the gamut 200 as shown in FIG. 2, color data may provide for determining the vertices 204.

With reference to FIG. 1, at 104, an initial surface may be created in a color space according to the color data. In some examples, the color space in which the initial surface is created may be an original color space, in which the color data are provided. For example, the color data may refer to the gamut of an image processing device. The color data may be provided in the RGB color space, or in the CMY(K) color space. The abbreviation CMY(K) may refer to either one of CMY and CMYK.

The initial surface may refer to an outer surface of a gamut reproduced in a color space from the color data. The outer surface of a gamut may be approximated by a plurality of partial surfaces. The outer surface of an actual gamut may be assumed to be smooth. Hence, the accuracy of an outer surface of a gamut that is obtained and approximated from sampling may be enhanced by smoothening. The smoothening may be performed by means of interpolation, thereby preserving originally provided vertices. Accordingly, a result obtained may be close to the real gamut.

At 106, the initial surface may be divided into patches, in particular first patches. A patch may refer to a partial surface bordered by edges connecting neighboring vertices. The patches may be polygons. For example, the patches may be triangles surrounded by three edges, or surrounded by three vertices, as illustrated in FIG. 2B.

In some examples, the initial surface may be created in a device-independent color space together with first patches. In other examples, the initial surface may be created in a device-independent color space, and then supplemented with the first patches. The term first patches as used herein may refer to the patches prior to a subdivision, and is therefore not limited to the patches obtained from the initial vertices or the color data. For example, providing the first patches may include dividing the initial surface into patches. Such a division may be performed recursively, iteratively or repeatedly, which are interchangeably used herein.

The partial surfaces may be formed by connecting neighboring vertices provided by the color data. In some examples, connecting of the neighboring vertices is performed according to a tessellation scheme, or according to a triangulation scheme. For example, with reference to FIG. 2B, tiling lines 206 may be added to the gamut 200 in addition to the sampling lines 202. In some examples, the tiling lines 206 may be provided along a three-dimensional space diagonal between a white point W and a black point B, i.e. parallel to a respective projection of the space diagonal on the respective outer surface of the cubic gamut 200. The white point W may correspond to a point at which each of the primary colors R, G and B are at zero. The black point B may correspond to a point at which each of the primary colors R, G and B are at a maximum value, for example 256. Both the sampling lines 202 and the tiling lines 206 may be considered as connecting lines connecting neighboring vertices 204.

Accordingly, each of the partial surfaces may be surrounded by a respective number of connecting lines, referred to as edges that connect neighboring vertices. As a result, the partial surfaces, which also are referred to as patches, may be represented as polygons connected to one another in a mesh-like structure. Accordingly, a mesh of patches may be provided. The patches as a whole may form the outer surface of the respective gamut and thus the initial surface.

FIG. 2C shows an initial surface 200′ is a device-independent CIELAB color space according to an example. In particular, the initial surface 200′ corresponds to the initial surface 200 as shown in FIG. 2B. As shown in FIG. 2C, the initial surface 200′ may have a shape that tapers towards negative a*-direction and an approximately constant cross-section along b*-direction. The initial surface 200′ may have, as a whole, a concave portion towards positive a*-direction.

FIGS. 2B and 2C show that the cubic shape of the initial surface 200 in the device-dependent RGB color space is deformed when converted into the initial surface 200′ in the device-independent CIELAB color space. Accordingly, the boundary surface of a gamut may not be well-defined when converted into a device-independent color space.

Triangulation may refer to providing a set of polygons based on a set of vertices. A triangulation scheme may refer to a mathematical or topological set of rules for executing a triangulation. For example, the triangulation scheme may be according to Delaunay-triangulation or Drichlet-triangulation. Tessellation may refer to creating a mesh of polygons, e.g. triangles, from data that refer to a surface.

Further with reference to FIG. 1, at 108, a first one of the first patches may be divided into second patches based on a topology of a second one of the first patches. For example, the first one of the first patches may be subdivided into the second patches, the subdivision taking into account the topology of the second one of the first patches. The topology of a patch may refer to a position, declination, torsion, or any other spatial property of the respective patch with respect to a respective color space. The topology may include any of said properties in absolute values or in relation to the topology of the first one of the first patches.

The terms division and subdivision may be interchangeably used herein. In some examples, the term subdivision as used herein may in addition indicate that a given surface defined by initial vertices is divided into partial surfaces by adding new vertices while maintaining the original vertices. In particular, the subdivision as disclosed herein may take into account nearby vertices when determining a new vertex associated with an edge of a respective first patch. The subdivision may be performed recursively, iteratively or repeatedly.

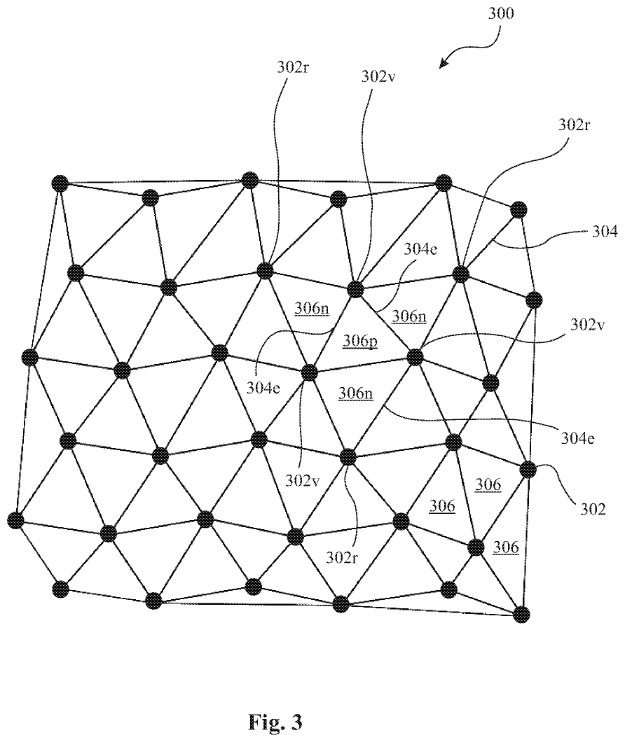

The division of the first patches into respective second patches may be performed as follows. FIG. 3 shows an example of an outer surface of a gamut 300 represented in a device-independent color space, such as the CIELAB color space. The outer surface comprises vertices 302, which are connected to one another by connecting lines 304, which may be referred to as edges. In this example, each of the vertices may be connected with six neighboring vertices according to the Delaunay-triangulation scheme. As a result, patches 306 may be obtained, which may be referred to as first patches.

It is assumed that a specific first patch 306p is to be subdivided into partial patches. The patch 306p is surrounded by edges 304e that connect the vertices 302v to one another. For the subdivision of the patch 306, a new vertex is determined respectively for each of the edges 304e based on topologies of the neighboring patches 306n. The topology of either of the neighboring patches 306n may be determined by the position, i.e. coordinates, of the respective remote vertex 302r relatively to the positions, i.e. coordinates, of the vertices 302v which the respective neighboring patch 306n share with the patch 306p. Accordingly, a position, declination, torsion, or any other spatial property of the neighboring patches 306n in the respective color space may be taken into account when determining the new vertices for the subdivision of the patch 306p. For example, a mathematical representation of the respective topology may be determined and multiplied by a corresponding weight factor. The weight factor may be obtained, for example, according to calculations, simulation results and/or empirically.

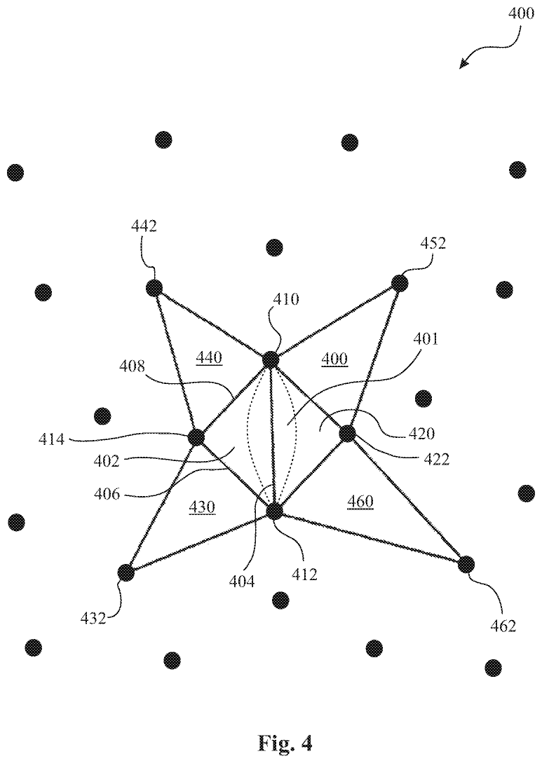

FIG. 4 shows an array of vertices 400. The vertices shown in FIG. 4 may be initial vertices provided by color data, or further include vertices obtained from a subdivision. A patch 402 may be surrounded by three edges 402, 406, 408 connecting vertices 410, 412, 414. The patch may be neighbored by further patches 420, 430, 440. For a subdivision of the patch 402, a respective new vertex may be determined for each of the edges 404, 406, 408. For the determination of a new vertex with respect to the edge 404, a topology of the patch 420 that is adjacent to the edge 404 may be taken into account. The topology of the patch 420 may be represented mathematically, for example, by means of the coordinates of a vertex 422 that belongs to the patch 420 and is spaced from the patch 402 that is to be subdivided. The resulting new vertex may be located within an area as indicated by dashed lines 401.

Further for the determination of the new vertex with respect to the edge 404, a respective topology of other patches 430, 440 that are adjacent to the patch 402 may be considered. In particular, the coordinates of vertices 432, 442 that are spaced from the patch 402 may be taken into account. In addition, a respective topology of further patches 450, 460 that are adjacent to the patch 420 sharing the edge 404 may be considered for the determination of the new vertex with respect to the edge 404. In particular, the coordinates of vertices 452, 462 that are spaced from the patch 420 may be taken into account.

According to an example, the coordinates of the vertices 410, 412 may be grouped into a first group. The coordinates of the vertices 414, 422 may be grouped into a second group. The coordinates of the four further vertices 432, 442, 452 and 462 may be grouped into a third group. Accordingly, any of the eight vertices 410, 412, 414, 422, 432, 442, 452, 462 are part of one group at a time. Said vertices 410, 412, 414, 422, 432, 442, 452, 462 may be different from one another.

For calculating the coordinates of the new vertex with respect to the edge 404, the coordinates of the vertices 410, 412, 414, 422, 432, 442, 452, 462 may be brought into a mathematical relation to one another. For example, the groups of vertices may be multiplied by a respective weight factor, and the products may be added altogether. The addition may correspond to a vectorial summation of the respective coordinates.

In a specific example, the first group of vertices may be added, e.g. by adding the respective vector representations of the vertices, and then multiplied by 0.1 to 0.9, or 0.2 to 0.8, or 0.25 to 0.75. The second group of vertices may be added and then multiplied by 0.01 to 0.5, or 0.05 to 0.4, or 0.1 to 0.3. The third group of vertices may be added and then multiplied by −0.2 to −0.005, or −0.1 to −0.01, or −0.07 to −0.05. Accordingly, the weigh factor for the third group of vertices may have a negative sign.

Alternatively or additionally, in a specific example, the coordinates of the new vertex P_new may be determined as follows:

P_new=0.5*(P410+P412)+2*c*(P414+P422)−c*(P432+P442+P452+P462)

wherein c is an adjustable parameter. For example, c may be between 0.1 and 0.01, or between 0.08 and 0.03, or between 0.07 and 0.05.

The subdivision scheme as described above may be referred to as the butterfly subdivision scheme, referring to the shape of in total six patches that are taken into account when determining a new vertex with respect to an edge. The second patches resulting from the subdivision as described above may be continuously differentiable patches maintaining the C1-continuity. Accordingly, a mesh of patches may be obtained having continuous derivatives.

Furthermore, since the subdivision is based on an affine combination of neighboring patches, the subdivision may be performed locally. Accordingly, equations that take into account a topology of the entire initial surface may become unnecessary, thereby optimizing processing resources.

By subdividing a polygon, or a patch, according to any of the above described scheme, topologies of the surrounding, adjacent, or neighboring polygons or patches may be taken into account. Accordingly, the division of a first patch into respective second patches may be performed based on a topology of another first patch, in particular based on topologies of multiple other first patches. In this manner, an accurate approximation to the real outer surface of a gamut may be provided.

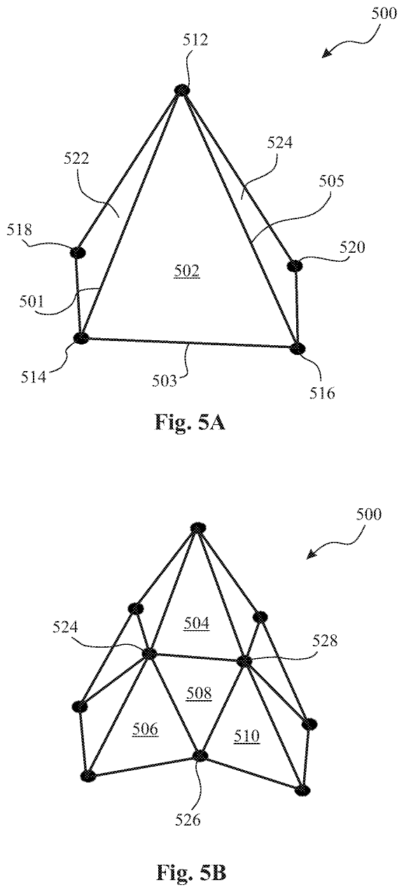

FIGS. 5A and 5B are schematic diagrams illustrating a process of dividing a first patch 502 into second patches 504, 506, 508, 510 according to another example. As an example, a body 500 has vertices 512, 514, 516, 518 and 520. The first patch 502 is surrounded by edges 501, 503, 505 connecting the vertices 512, 514, 516.

According to a subdivision, new vertices 524, 526, 528 are determined with respect to the edges 501, 503, 505, respectively. By connecting the new vertices 524, 526, 528, the first patch 502 is divided into four second patches 504, 506, 508, 510. As shown in FIG. 5B, the determined new vertices may be located close to the respective edge, or distinctly spaced from the respective edge. For example, the new vertices 524, 528 almost overlap the respective edge 501, 505, while the new vertex 526 is clearly spaced apart from the edge 503. The subdivision of the first patch 502 into the second patches 504, 506, 508, 510 may provide an approximation to an acutal surface in which the first patch 502 may be a curved hull instead of a flat triangle.

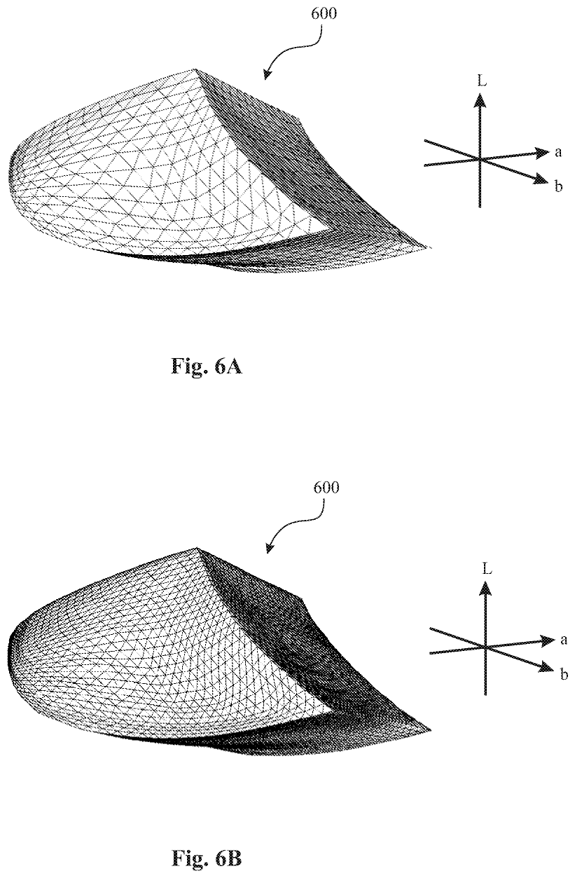

FIGS. 6A and 6B are schematic diagrams of a gamut 600 represented in a CIELAB color space before and after subdivisions of patches into respective partial patches according to examples of a method as disclosed herein. As mentioned above, the patches as shown in FIG. 6A before the subdivision may be referred to as first patches, and the patches as shown in FIG. 6B after the subdivision may be referred to as second patches.

A comparison of the representations of the gamut 600 and 600′ in FIGS. 6A and 6B may show that the examples of a method as disclosed herein results in a refinement of the outer surface of the gamut 600. The outer surface of a gamut may represent a boundary thereof, which may be used for gamut mapping or analysis of the gamut, for example, for optimization. According to examples of a method disclosed herein, an approximation may be provided by means of smoothening and interpolation, therefore reproducing the real gamut boundary to a satisfactory extent.

In some examples, the method further may comprise determining the following: a first surface normal to a first one of the second patches; a second surface normal to a second one of the second patches; and a relative angle between the first surface normal and the second surface normal. In such examples, the division of the first one of the first surface into the second surfaces may be stopped or undone, if the relative angle is smaller than a threshold angle.

A test may be performed determining whether or not the subdivision of a specific patch may provide additional information on the color data. In particular, the threshold angle may be defined such as to reflect a desired balance between the processing resources that are required for performing a respective subdivision and the information gain to be expected therefrom. For example, the test may determine whether, or to what extent, two adjacent patches are in-plane, or coplanar, or arranged parallel to each other in a respective color space. In some examples, if the first one and the second one of the first patches are approximately coplanar, the method may determine that performing the subdivision of the first one of the first patches may not provide additional information on the color data, and defer the respective subdivision. For example, the coplanarity of two patches may be determined by a comparison of their surface normals.

Such a test may allow for reducing redundant subdivisions, thereby optimizing the use of the processing resources. Furthermore, the test may provide an adaptive subdivision, which allows customization of the method, for example, in terms of the processing resources and level of details, according to individual requirements.

In the examples discussed above, a first patch is divided into the second patches based on topologies of multiple first patches neighboring the first one of the first patches. In some examples, multiple ones of the first patches up to all of the first patches, are divided into respective second patches. In this regard, the term second patches may be used for distinguishing from the first patches as introduced above. Furthermore, the second patches may be distinguishable by a division step that takes into account the topology of a further first patch other than the first patch to be divided.

In some examples, the first one of the first patches that is to be divided into the second patches may be a polygon surrounded by edges connecting initial vertices provided by the color data. According to an example of the method, respective new vertices may be determined associated with each of the edges, based on a topology of a respective second one of the first patches. The first one of the first patches may be divided into the second patches by connecting the new vertices.

In some examples, at least one of a first group, a second group, and a third group of initial vertices may be determined. The first group of initial vertices may comprise a first initial vertex and a second initial vertex that are connected according to a triangulation scheme. The connecting line between the first and second initial vertices may be referred to as an edge. The second group of initial vertices may comprise a third initial vertex and a fourth initial vertex that are closest to the edge. The third group of initial vertices may comprise four further initial vertices that are next closest to the edge. In particular, the first initial vertex, the second initial vertex, the third initial vertex, the fourth initial vertex and the four further initial vertices may all be different from one another. Accordingly, each of the first, second, third, fourth and the four further initial vertices may be associated with only one of the first, second and third groups of initial vertices.

In such examples, the division of the first one of the first patches into the second patches may be performed based on the coordinates of the initial vertices of the first, second and third groups. In more specific examples, the division of the first one of the first patches into the second patches may involve weighting mathematical representations of the first group, the second group and the third group by a first weight factor, a second weight factor, and a third weight factor, respectively. The mathematical representations may include a vectorial summation of the respective coordinates.

In some examples, the first weight factor may be between 0.1 and 0.9, or between 0.2 and 0.8, or between 0.25 and 0.75. In some examples, the second weight factor may be between 0.01 and 0.5, or 0.05 and 0.4, or 0.1 and 0.3. In some examples, the third weight factor may be between −0.2 and −0.005, or between −0.1 and −0.01, or between −0.07 and −0.05. In specific examples, the coordinates of the respective initial vertices of the first, second and third groups, multiplied by the respective factors, may be added together to determine a new vertex associated to a respective edge.

In some examples, a first one of the second patches is further divided into a plurality of patches based on a topology of a second one of the second patches. In other examples, multiple ones of the second patches, or all of the second patches if applicable, may be divided into a respective plurality of patches. The division may be performed similar to the divisions of the first patches into the respective second patches. The patches resulting from the subdivision of the second patches may be referred to as third patches in order to differentiate from the first and second patches from anteceding division steps.

In some examples, the subdivision of existent patches may be repeatedly performed in order to obtain even smaller patches. For example, the division of the first one of the first patches into the second patches may correspond to a tessellation process, in which a set of input patches is divided into a set of output patches. In an example of the method, the tessellation process is iteratively performed, with the set of output patches becoming the set of input patches in a following iteration.

The repetition of the subdivision may also be understood as multiple iterations, or recursively performing the subdivision. By repeatedly subdividing a patch (e.g. the first one of the first patches), or a mesh of patches, and the resulting partial patches (e.g. the second patches into which the first one of the first patches is divided), a granularity of resulting sets of patches may be increased. As a result, a level of smoothening or interpolation of the gamut boundary may be increased. This may reduce the need for clipping or clustering when mapping from a source gamut to a target gamut.

The recursion of performing the subdivision may be limited by processing resources, such as a processor capacity, or desired processing time. In some examples, the recursion of performing the subdivision may be by default limited to an integer number. In further examples, the recursion of performing the subdivision may be stopped when reaching a predetermined level of granularity. The granularity as used herein may refer to a level of details with reference to original data to start from. For example, the color data may be considered as original data to start a recursion of subdivisions from.

A subdivision scheme may refer to a scheme for a surface subdivision, i.e. representing a smooth surface via the specification of a coarser piecewise linear polygon mesh. The smooth surface may be calculated from the coarse mesh as the limit of recursive subdivision of each polygonal face into smaller faces that better approximate the smooth surface. In some examples, the first one of the first patches is divided into the second patches based on the topology of the second one of the first patches according to a butterfly subdivision scheme. The butterfly subdivision scheme may refer to a subdivision scheme for surfaces based on a four-point interpolatory subdivision scheme for curves. More details or examples with respect to the butterfly subdivision scheme are as discussed below.

According to a further aspect, a machine-readable medium is disclosed. The machine-readable medium may store instructions corresponding to the examples of a method as described above. Further, the machine-readable medium may comprise instructions to, when executed by a processor, cause the processor to receive color data including initial vertices in a first color space. The machine-readable medium may further cause the processor to create an initial surface corresponding to the color data in a second color space. The initial surface may be subdivided into first patches according to a triangulation scheme performed on the initial vertices. The machine-readable medium may cause the processor to determine, for each edge of the first patches, a respective new vertex based on positions of a subset of initial vertices that are closest to the respective edge, thereby obtaining new vertices. The machine-readable medium may cause the processor to perform a subdivision scheme on a set of vertices comprising the new vertices and the initial vertices, thereby dividing the first patches into second patches.

In some examples, the machine-readable medium may contain instructions according to any of the examples of a method disclosed herein. For example, the machine-readable medium may contain instructions to be executed by a processor and, if executed, cause the processor to perform the method as described above. In this manner, the examples of a method as described above may be executable by a machine with a processing capability.

According to a further aspect, a system is disclosed. The system may comprise a storage device to store and provide color data including initial vertices in a first color space representative of a color set reproducible by an image processing device. The system may further include a computing device to receive the color data and perform a triangulation on the initial vertices to create an initial surface subdivided into first patches in a second color space. The computing device may be able to subdivide one of the first patches into second patches based on a topology of another one of the first patches adjacent to the one first patch.

In some examples, the system may be suitable for performing any of the examples of a method disclosed herein. For example, the system may be able to receive and execute any of the instructions stored in a machine-readable medium disclosed herein.

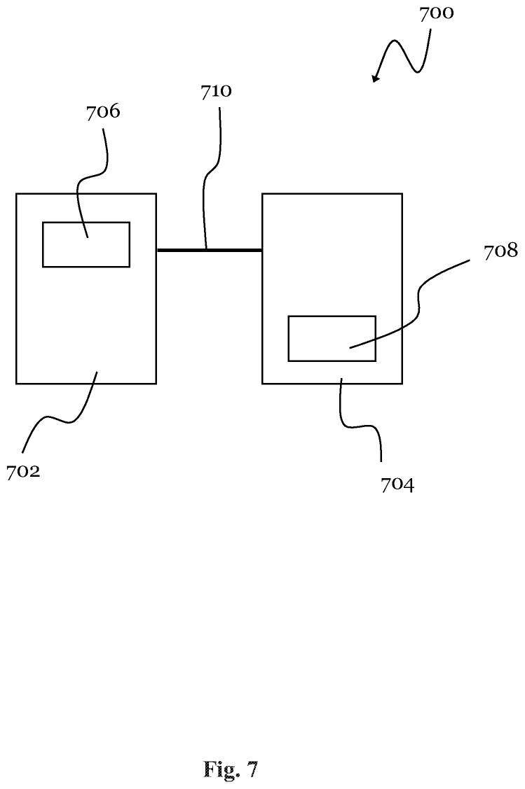

FIG. 7 is a schematic diagram of a system 700 according to an example. The system 700 may comprise a storage device 702 and a computing device 704. The storage device may store and provide color data 706. The color data 706 may include initial vertices in a first color space. The first color space may be a source color space, for example a RGB color space or a CMY(K) color space.

The initial vertices may be representative of a color set reproducible by an image processing device. The computing device 704 may receive the color data 706 and perform a triangulation on the initial vertices to create an initial surface subdivided into first patches in a second color space. The second color space may be a target color space, for example a CIELAB color space.

The computing device 704 may subdivide one of the first patches into second patches based on a topology of another one of the first patches adjacent to the one first patch. For this purpose, the computing device 704 may comprise a processor 708 capable of receiving and processing the color data and the corresponding instructions.

The system 700 may be realized within an image processing device, such as a printing device, a display device, or an image capture device. In other examples, the storage device 702 and the computing device 704 may be provided remote from each other and communicatively coupled, e.g. via a network 710. The storage device 702 may be provided in a server device or at a image processing device. The computing device 704 may be provided by a client device, such as a personal computer accessing an image processing device. Alternatively or additionally, an image processing device may be provided with the computing device 704.

The storage device 702 may be capable of storing any of the instructions corresponding to the examples of a method as disclosed herein. The computing device 1104 may be capable of executing any of the instructions corresponding to the examples of a method as disclosed herein.

Examples described herein provide for smoothening or interpolation of a gamut boundary, thereby allowing for reducing need for clipping or clustering during gamut mapping. The present examples described enable a method for smoothening or interpolation of a gamut boundary whilst keeping vertices obtained from original or initial color data. For example, when transforming from a RGB source color space to a CIELAB target color space, the gamut as reconstructed from the original color data in the source color space may be deformed. The present disclosure provides an approximation to the real gamut boundary without re-tessellating the vertices but by means of a recursive subdivision.

The examples of a method as disclosed herein may allow for smoothening, or an interpolation, of a gamut boundary in a given color space. In particular, the smoothening or interpolation may be applied to areas between vertices or nodes that are known from the color data, which are referred to as the initial vertices in the present disclosure. The smoothening or interpolation of the gamut boundary may indicate that polygons obtained from tessellation or triangulation schemes may rather be hulls having a respective curvature instead of being flat. According to the examples as disclosed herein, a subdivision of a patch, or a mesh of patches, is performed, while preserving the initial vertices, thereby obtaining results that are close to the color data. Accordingly, the examples of the present disclosure may provide an accurate representation of the gamut boundary. In some examples, the subdivision may be performed recursively to increase granularity, which may reduce the need for clipping or clustering, when mapping from a source gamut to a target gamut. The disclosure may allow for increasing the performance in terms of the processing resource requirement and preservation of the original color data.

1. A method, comprising:
receiving color data;
creating an initial surface corresponding to the color data in a color space;
dividing the initial surface into first patches; and
dividing a first one of the first patches into second patches based on a topology of a second one of the first patches.

2. The method of claim 1,
wherein the topology of the second one of the first patches includes coordinates of an initial vertex.

3. The method of claim 1,
wherein the first one of the first patches is divided into the second patches based on topologies of multiple first patches neighboring the first one of the first patches.

4. The method of claim 1,
wherein the first one of the first patches is a polygon surrounded by edges connecting the initial vertices,
wherein the method further comprises:
determining a respective new vertex associated with each of the edges based on a topology of a respective second one of the first patches; and
connecting the new vertices, thereby dividing the first one of the first patches into the second patches.

5. The method of claim 1,
wherein the method further comprises determining the following:
a first group of initial vertices comprising a first one and a second one of the initial vertices that are connected according to a triangulation scheme;
a second group of initial vertices comprising a third one and a fourth one of the initial vertices that are closest to a connecting line between the first and second ones of the initial vertices;
a third group of initial vertices comprising four further ones of the initial vertices that are next closest to the connecting line;
wherein each of the first, second, third, fourth and the four further initial vertices are associated with only one of the first, second and third groups of initial vertices,
wherein the division of the first one of the first patches into the second patches is performed based on the coordinates of the initial vertices of the first, second and third groups.

6. The method of claim 5,
wherein the division of the first one of the first patches into the second patches is involves weighting mathematical representations of the first group, the second group and the third group by a first weight factor, a second weight factor, and a third weight factor, respectively,
wherein at least one of the following conditions is fulfilled:
the first weight factor is 0.1 to 0.9;
the second weight factor is 0.01 to 0.5; and
the third weight factor is −0.3 to −0.005.

7. The method of claim 1,
wherein the first one of the first patches is divided into the second patches based on the topology of the second one of the first patches according to a butterfly subdivision scheme.

8. The method of claim 1, further comprising:
dividing a first one of the second patches into third patches based on a topology of a second one of the second patches.

9. The method of claim 1,
wherein dividing the first one of the first patches into the second patches corresponds to a subdivision of an input patch into a set of output patches,
wherein the method further comprises iteratively performing the subdivision, with the set of output patches becoming the input patch in a following iteration.

10. The method of claim 1, further comprising:
determining a first surface normal to a first one of the second patches;
determining a second surface normal to a second one of the second patches;
determining a relative angle between the first surface normal and the second surface normal;
if the relative angle is smaller than the threshold angle, undoing the division of the first one of the first surface into the second surfaces.

11. The method of claim 1,
wherein the initial vertices are representative of a set of colors reproducible by an image processing device.

12. The method of claim 1,
wherein the initial vertices relate to a RGB color space,
wherein the division of the first one of the first patches into the second patches is performed in a L*a*b* color space.

13. The method of claim 1,
wherein the initial surface is divided into the first patches according to a triangulation scheme.

14. A machine-readable medium, comprising instructions that, if executed by a processor, cause the processor to:
receive color data including initial vertices in a first color space;
create an initial surface corresponding to the color data in a second color space, the initial surface subdivided into first patches according to a triangulation scheme performed on the initial vertices;
for each edge of the first patches, determining a respective new vertex associated based on positions of a subset of initial vertices that are closest to the respective edge, thereby obtaining new vertices;
performing a triangulation scheme on a set of vertices comprising the new vertices and the initial vertices, thereby dividing the first patches into second patches.

15. A system comprising:
a storage device to store and provide color data including initial vertices in a first color space representative of a color set reproducible by an image processing device;
a computing device to receive the color data and perform a triangulation on the initial vertices to create an initial surface subdivided into first patches in a second color space;
wherein the computing device is to subdivide one of the first patches into second patches based on a topology of another one of the first patches adjacent to the one first patch.
